(19) United States
(12) Patent Application Publication
(10) Pub. No.: US 2009/0181305 A1
(43) Pub. Date: Jul. 16, 2009

(54) Non-Aqueous Electrolyte Secondary Battery

(76) Inventors: Masatoshi Nagayama, Osaka (JP); Takuya Nakashima, Osaka (JP); Yoshiyuki Muraoka, Osaka (JP); Takashi Takeuchi, Osaka (JP)

Correspondence Address: MCDERMOTT WILL & EMERY LLP, 600 13TH STREET, NW, WASHINGTON, DC, 20005-3096, US

(21) Appl. No.: 11/884,382

(22) PCT Filed: Jun. 9, 2006
(86) PCT No.: PCT/JP2006/011590

§ 371 Date: Aug. 15, 2007

(30) Foreign Application Priority Data
Jun. 14, 2005 (JP) 2005-173374

(51) Int. Cl. H01M 4/32

(52) U.S. Cl. 429/223

(57) ABSTRACT

Disclosed is a non-aqueous electrolyte secondary battery including a positive electrode, a negative electrode and a non-aqueous electrolyte. The positive electrode includes a positive electrode active material layer and the negative electrode includes a negative electrode active material layer. The positive electrode active material layer includes a lithium-containing metal oxide containing nickel as a positive electrode active material. The area of the positive electrode active material layer per unit battery capacity is in a range of 190 to 800 cm²/Ah. A porous heat resistant layer is disposed between the positive electrode and the negative electrode, and the ratio of an amount of the non-aqueous electrolyte relative to an area of the porous heat resistance layer is 70 to 150 ml/m².

### TECHNICAL FIELD

The present invention relates to non-aqueous electrolyte secondary batteries, and specifically relates to non-aqueous electrolyte secondary batteries capable of suppressing a reduction in capacity due to vibration.

### BACKGROUND ART

In recent years, non-aqueous electrolyte secondary batteries, particularly lithium ion secondary batteries have been actively developed as secondary batteries having a high operating voltage and a high energy density, for use as power sources for driving portable electronic devices such as mobile phones, laptop personal computers and video camcorders. Moreover, for use as power sources for equipment requiring high power output such as electric power tools or electric vehicles, the development thereof has been accelerated. The lithium ion secondary batteries have been actively developed as high capacity power sources that will replace commercially available nickel metal hydride storage batteries, particularly for use in hybrid electric vehicles (hereinafter referred to as HEVs).

Such high power output lithium ion secondary batteries are, unlike lithium ion secondary batteries for use in small consumer devices, designed to have a large electrode area to allow the battery reaction to proceed smoothly so that a large current can be taken out instantaneously.

In the use for HEV application, unlike the use for small consumer device application, the battery capacity consumed is great. For this reason, with resources and costs taken into consideration, there has been an attempt to employ a positive electrode active material containing nickel or manganese instead of a positive electrode active materiel containing expensive cobalt (LiCoO₂ etc.) in the batteries for use in HEVs (See Patent Document 1). The positive electrode active material containing nickel or manganese is exemplified by LiNi₁₋ₓMₓO₂ and LiMn₁₋ₓMₓO₂ (where M is a transition metal etc).

Among these, a positive electrode active material mainly composed of nickel such as LiNi₁₋ₓMₓO₂ (hereinafter referred to as a nickel-based positive electrode active material) is promising as an active material for use in high power output lithium ion secondary batteries because of their large discharge capacity.

Meanwhile, a microporous separator made of resin has a disadvantage in that a short-circuit portion is easily expanded by melting, etc. Assuming the case where a short-circuit is caused between the positive electrode and the negative electrode by a foreign matter having entered into the electrode assembly in the process of fabricating the battery or an accident, there has been proposed to use in combination a microporous separator made of resin and a porous heat resistant layer including an inorganic filler (solid fine particles) and a binder (See Patent Document 2). Herein, the porous heat resistant layer is carried on the active material layer of the electrode.

The porous heat resistant layer is charged with an inorganic filler such as alumina or silica. The filler particles are combined with one another by a relatively small amount of binder. Since the high power output lithium ion secondary batteries have a large electrode area as described above, introduction of this technique will presumably bring a significant improvement in reliability while maintaining output characteristics.

### Patent Document 1: Japanese Laid-Open Patent Publication No.

Patent Document 2: Japanese Laid-Open Patent Publication No. Hei 7-220759 (Japanese Patent Publication No. 3371301)

### DISCLOSURE OF THE INVENTION

### Problem to be Solved by the Invention

A high power output lithium ion secondary battery that includes a positive electrode including a nickel-based positive electrode active material and a heat resistant layer as disclosed in Patent Document 2, however, shows a significant reduction in the battery capacity when actually used in an electric tool or an HEV. Dismantling of the battery whose battery capacity had been reduced revealed that the positive electrode and the negative electrode were displaced in the electrode assembly, unlike the case where the conventional microporous separator made of resin was used. Therefore, it is considered that the occurrence of internal short circuit between the positive electrode and the negative electrode was suppressed by virtue of the porous heat resistant layer; however, the area in which the positive electrode and the negative electrode were opposing to each other was reduced because the positive electrode and the negative electrode were displaced, and as a result, the battery capacity was significantly reduced.

The present invention therefore intends to solve the problems as described above and provide a high power output non-aqueous electrolyte secondary battery excellent in vibration resistance.

### Means for Solving the Problem

A non-aqueous electrolyte secondary battery of the present invention includes a positive electrode, a negative electrode and a non-aqueous electrolyte. The positive electrode includes a positive electrode active material layer, and the negative electrode includes a negative electrode active material layer. The positive electrode active material layer includes a lithium-containing metal oxide containing nickel as a positive electrode active material. An area of the positive electrode active material layer per unit battery capacity is in a range of 190 to 800 cm²/Ah. A porous heat resistant layer is disposed between the positive electrode and the negative electrode. A ratio B/A of an amount B of the non-aqueous electrolyte relative to an area A of the porous heat resistance layer is 70 to 150 ml/m². For example, the positive electrode active material layer is carried on both faces of a positive electrode current collector. In such a case, the above described area of the positive electrode active material layer is half of the contact area between the positive electrode active material layer and the positive electrode current collector. In other words, the area of the positive electrode active material layer refers to an area of the positive electrode active material layer carried on one face of the positive electrode current collector.

For example, in the case where the negative electrode active material layer is carried on both faces of a negative electrode current collector and, on each of the both negative electrode active material layers, the porous heat resistant layer is carried, the above described area A of the porous heat resistant layer is a sum of the areas of the two porous heat resistant layers.

It is preferable that a microporous separator made of resin is disposed between the positive electrode and the porous heat resistant layer or between the negative electrode and the porous heat resistant layer.

It is preferable that the porous heat resistant layer is bonded on the positive electrode active martial layer or the negative electrode active material layer. It is further preferable that the porous heat resistant layer includes an insulating filler and a binder. Herein, the insulating filler is preferably an inorganic oxide.

One embodiment of the present invention uses a compound represented by the following formula (1) as the positive electrode active material:

LiNi_{1-a-b-c-d}CoₐAl_{b}M¹_{c}M²_{d}O₂ (1)

where M¹ is at least one selected from the group consisting of Mn, Ti, Y, Nb, Mo and W; M² is at least two selected from the group consisting of Mg, Ca, Sr and Ba; Mg and Ca are essential; 0.05≦a≦0.35; 0.005≦0.1; ≦c≦0.05; and 0.0001≦d≦0.05.

Another embodiment of the present invention uses a compound represented by the following formula (2) as the positive electrode active material:

LiNiₐCo_{b}Mn_{c}M³_{d}O₂ (2)

where M³ is at least one selected from the group consisting of Mg, Ti, Ca, Sr and Zr; 0.25≦a≦0.5; 0≦b≦0.5; 0.25≦c≦0.5; and 0≦d≦0.1. In the formula (2) above, it is preferable that 0≦b≦0.2 and 0.01≦d≦0.1.

Yet another embodiment of the present invention uses a compound represented by the following formula (3) as the positive electrode active material:

LiNiₐMn_{b}M⁴_{c}O₄ (3)

where M⁴ is at least one selected from the group consisting of Co, Mg, Ti, Ca, Sr and Zr, 0.4≦a≦0.6, 1.4≦b≦1.6, and 0≦c≦0.2.

In still another embodiment of the present invention, the positive electrode active material includes at least two selected from the group consisting of the compounds represented by the above formula (1), the above formula (2) and the above formula (3).

### EFFECT OF THE INVENTION

In the present invention, since the ratio of an amount of the non-aqueous electrolyte relative to an area of the porous heat resistant layer is 70 to 150 ml/m², the porous heat resistant layer expands moderately, and thus the winding displacement in the electrode assembly can be prevented. Moreover, since the area of the positive electrode active material layer per unit battery capacity is 190 to 800 cm²/Ah, the output characteristics of the battery can be improved. Therefore, according to the present invention, it is possible to provide a non-aqueous electrolyte secondary battery with excellent vibration resistance and high power output characteristics.

### BRIEF DESCRIPTION OF THE DRAWINGS

FIG. 1 A vertical cross sectional view schematically showing a part of a non-aqueous electrolyte secondary battery according to an embodiment of the present invention.

FIG. 2 A vertical cross sectional view schematically showing a part of a non-aqueous electrolyte secondary battery according to another embodiment of the present invention.

### BEST MODE FOR CARRYING OUT THE INVENTION

The present invention will be hereinafter described with reference to the drawings.

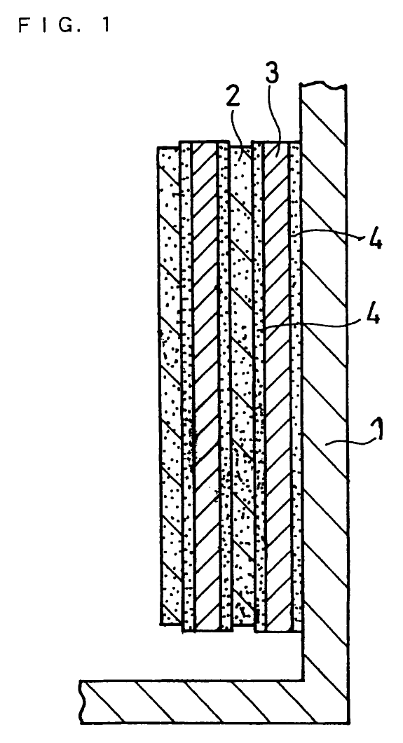

FIG. 1 shows a cross sectional view showing a part of a non-aqueous electrolyte secondary battery according to an embodiment of the present invention.

The non-aqueous electrolyte secondary battery as shown in the figure comprises an electrode assembly including a positive electrode 2, a negative electrode 3, and a porous heat resistant layer 4 interposed between the positive electrode and the negative electrode, a battery case 1 accommodating the electrode assembly, and a non-aqueous electrolyte (not shown). In this electrode assembly, the positive electrode 2, the negative electrode 3 and the porous heat resistant layer 4 are wound.

The positive electrode 2 includes a positive electrode current collector and positive electrode active material layers carried on both faces thereof. The positive electrode active material layer includes a positive electrode active material, a binder and a conductive agent as needed. As the positive electrode active material, a lithium-containing composite oxide containing nickel is used. The negative electrode 3 includes a negative electrode current collector and negative electrode active material layers carried on both faces thereof. The negative electrode active material layer includes a negative electrode active material, and a binder and a conductive agent as needed.

In the non-aqueous electrolyte secondary battery as shown in FIG. 1, the porous heat resistant layer 4 is disposed on each of the two negative electrode active material layers to insulate the positive electrode from the negative electrode.

In the present invention, the area of the positive electrode active material layer per unit battery capacity is in the range of 190 to 800 cm²/Ah, and the ratio B/A of an amount B of the non-aqueous electrolyte relative to an area A of the porous heat resistant layer is 70 to 150 ml/m². Herein, the area A of the porous heat resistant layer includes an area of the portion of the porous heat resistant layer located in the outermost round of the electrode assembly.

The inventors of the present invention have conducted intensive studies and arrived at the following three findings. The first finding is as follows. The variation in volume during charge and discharge of a nickel-based positive electrode active material is small, compared with the conventional lithium-containing metal oxide mainly composed of cobalt (hereinafter referred to as a “cobalt-based positive electrode active material”). Therefore, in a high power output lithium ion secondary battery having a large electrode area, the volume expansion of the electrode assembly is smaller than before.

The second finding is as follows. In the conventional electrode assembly, impregnation of a non-aqueous electrolyte causes a moderate level of volume expansion of the electrode assembly. The expanded electrode assembly is then pushed to the battery case. This prevents the winding displacement in the electrode assembly even when the battery is mounted on equipment that will be exposed to continuous vibration such as an electric power tool or an HEV.

The third finding is as follows. The porous heat-resistant layer is excellent in short circuit resistance, and moreover the volume thereof is expanded by being impregnated with a non-aqueous electrolyte to a moderate extent. Therefore, even when the nickel-based positive electrode active material is employed, the volume of the electrode assembly can be sufficiently expanded.

The porous heat resistant layer 4 may include insulating filler particles as a main material and a binder for bonding the insulating filler particles. Alternatively, the porous heat resistant layer may include a heat resistant resin. Examples of the heat resistant resin include aramid and polyimide. In order to improve the mechanical strength of the porous heat resistant layer, it is preferable that the porous heat resistant layer includes an insulating filler and a binder.

The effect of the volume expansion of the porous heat resistant layer 4 that prevents the winding displacement in the electrode assembly has a correlation with an area of the porous heat resistant layer 4 and an amount of the non-aqueous electrolyte to be injected. The ratio B/A of an amount B of the non-aqueous electrolyte relative to an area A of the porous heat resistant layer 4 is 70 to 150 ml/m². In the case where the porous heat resistant layer includes an insulating filler and a binder, the binder swells by absorbing the non-aqueous electrolyte, to cause expansion of the porous heat resistant layer, whereby the winding displacement in the electrode assembly is prevented. In the case where the porous heat resistant layer is composed of a heat resistant resin, as is the case above, the heat resistant resin swells by absorbing the non-aqueous electrolyte, to cause expansion of the porous heat resistant layer, whereby the winding displacement in the electrode assembly is prevented.

When the ratio B/A of an amount B of the non-aqueous electrolyte relative to an area A of the porous heat resistant layer 4 is less than 70 ml/m², since the degree of swelling of the binder included in the porous heat resistant layer 4 is reduced, the winding displacement in the electrode assembly cannot be sufficiently prevented. When the ratio B/A is greater than 150 ml/m², in the case of a high power output non-aqueous electrolyte secondary battery having a sufficiently large electrode area, gas generation during high temperature storage is significant. For this reason, it is necessary that the ratio B/A falls within a range of 70 to 150 ml/m². In this range, it is preferable that the ratio B/A is 100 to 110.

In the case where the porous heat resistant layer includes an insulating filler and a binder, the ratio of the binder relative to the total of the insulating filler and the binder is preferably 1 to 10% by weight, and more preferably 2 to 4% by weight. When the ratio of the binder is greater than 10% by weight, the porous heat resistant layer cannot include a sufficient number of empty pores, and thus clogging may occur therein, resulting in a reduction in discharge characteristics. When the ratio of the binder is less than 1% by weight, for example, in the case where the porous heat resistant layer is carried on the active material layer, the bonding strength is reduced and thus the porous heat resistant layer may be peeled off from the active material layer.

The thickness of the porous heat resistant layer is preferably 3 to 7 μm. If the porous heat resistant layer functions only as an insulator, the thickness of 2 μm is satisfactory for that purpose. However, when the thickness of the porous heat resistant layer is less than 3 μm, it is impossible to obtain a sufficient effect of preventing the winding displacement due to swelling of the porous heat resistant layer. For the purpose of inserting the electrode assembly into a battery case only, it is satisfactory if the thickness of the porous heat resistant layer is not greater than 8 μm. However, when the porous heat resistant layer exceeds 7 μm, the porous heat resistant layer swells excessively and thus the discharge characteristics are degraded.

It should be noted that when the ratio B/A is in the range of 70 to 150 ml/m², if the thickness of the porous heat resistant layer is varied within the range above, it is considered that a sufficient amount of non-aqueous electrolyte is absorbed into the porous heat resistant layer.

The porosity of the porous heat resistant layer is preferably 30 to 65%, and more preferably 40 to 55%. When the porosity of the porous heat resistant layer is greater than 65%, the structural strength of the porous heat resistant layer may be reduced. When the porosity of the porous heat resistant layer is less than 30%, the porous heat resistant layer cannot include a sufficient number of empty pores, and thus clogging may occur therein, resulting in a reduction in discharge characteristics.

The porosity of the porous heat resistant layer can be determined, for example, using the thickness of the porous heat resistant layer, the absolute specific gravities of the insulating filler and the binder, the weight ratio of the insulating filler and the binder, and the like. For example, the thickness of the porous heat resistant layer can be determined by cutting the porous heat resistant layer and measuring the thickness thereof in the cross section at about 10 points with an electron microscope. The mean value of the measured values may be referred to as the thickness of the porous heat resistant layer.

The porous heat resistant layer 4 may be disposed, for example, on at least one of the electrodes of the positive electrode 2 and the negative electrode 3. Herein, the porous heat resistant layer is preferably bonded on the active material layer of at least one of the electrodes so that the porous heat resistant layer is interposed between the positive electrode and the negative electrode.

In view of reducing the number of production process, the porous heat resistant layer is preferably disposed on either one of the electrodes of the positive electrode and the negative electrode. In a non-aqueous electrolyte secondary battery, in general, the area of the negative electrode active material layer is larger than that of the positive electrode active material layer. Therefore, the porous heat resistant layer is preferably disposed on the negative electrode 3 because this can provide a reliable insulation between the positive electrode 2 and the negative electrode 3.

Examples of the insulating filler which can be used in the porous heat resistant layer 4 include, for example, resin beads and an inorganic oxide with high heat resistance. As the inorganic oxide, a compound having a high specific heat, a high thermal conductivity and a high resistance to thermal shock is used. Such a compound is exemplified by alumina, titania, zirconia and magnesia.

Examples of the binder which can be used in the porous heat resistant layer include, for example, polyvinylidene fluoride, polytetrafluoroethylene and modified acrylic rubber particles (BM-500B (trade name) available from Zeon Corporation, Japan). In the case where polytetrafluoroethylene or modified acrylic rubber particles are used as the binder, the binder is preferably used in combination with a thickener. The thickener is exemplified by carboxymethyl cellulose, polyethylene oxide and modified acrylic rubber (BM-720H (trade name) of available from Zeon Corporation, Japan).

Since the binder and the thickener as described above are excellent in affinity for a non-aqueous electrolyte, they have a property of swelling by absorbing a non-aqueous electrolyte, although the degree of swelling differs. Swelling of the binder and the thickener by absorbing a non-aqueous electrolyte allows the porous heat resistant layer 4 to expand moderately.

The porous heat resistant layer may be formed on the active material layer in the following manner.

An insulating filler as described above, a binder and a thickener as needed, as described above, and an appropriate amount of solvent or dispersion medium are mixed to give a paste. The paste thus obtained is applied on an active material layer, and then dried to form a porous heat resistant layer on the active material layer. Mixing of the insulating filler, the binder, and the solvent or the dispersion medium may be carried out, for example, with a double arm kneader. Applying of the paste on the active material layer may be carried out, for example, with a doctor blade method or a die coating method.

The area of the positive electrode active material layer per unit battery capacity is 190 to 800 cm²/Ah. With the area in this range, improved battery output characteristics can be obtained. The area of the positive electrode active material layer per unit battery capacity is preferably 190 to 700 cm²/Ah.

When the area of the positive electrode active material layer per unit battery capacity is less than 190 cm²/Ah (i.e., for conventional consumer use), the output characteristics are reduced because of the small area of the electrode. Moreover, in this case, since the area of the porous heat resistant layer 4 is also small, the volume expansion of the electrode assembly is insufficient. As a result, it is impossible to completely prevent the winding displacement in the electrode assembly. When the area of the positive electrode active material layer per unit battery capacity exceeds 800 cm²/Ah, the thickness of the active material layer per one face of the current collector is as thin as approximately 20 μm. This thickness of the active material layer is equal only to the thickness of two positive electrode active material particles of an average type (median size: approximately 10 μm). Therefore, if such an active material layer is formed, for example, using a positive electrode material mixture paste, it is difficult to apply the past on the current collector uniformly and thus the positive electrode cannot be produced stably.

It should be noted that in a typical non-aqueous electrolyte secondary battery, the positive electrode functions as an electrode for capacity regulation. In other words, the capacity of the negative electrode is made larger than that of the positive electrode. For example, the area of the active material layer of the negative electrode 3 is made larger than that of the active material layer of the positive electrode 2, and in the electrode assembly, the positive electrode and the negative electrode are arranged so that the active material layer of the negative electrode 3 completely covers the active material layer of the positive electrode 2.

The positive electrode active material includes a lithium-containing metal oxide containing nickel. The following three lithium composite oxides are preferable as the lithium-containing metal oxide containing nickel, in view of improving the capacity.

The lithium-containing metal oxide containing nickel may be a compound represented by the following formula (1):

LiNi_{1-a-b-c-d}CoₐAl_{b}M¹_{c}M²_{d}O₂ (1)

where M¹ is at least one selected from the group consisting of Mn, Ti, Y, Nb, Mo and W; M² is at least two selected from the group consisting of Mg, Ca, Sr and Ba; Mg and Ca are essential; 0.05≦a≦0.35; 0.005≦b≦0.1; 0.0001≦c≦0.05; and 0.0001≦d≦0.05. The oxide represented by the above formula (1) has a larger discharge capacity than the conventional cobalt-based positive electrode active material. However, when the molar ratio a of cobalt is less than 0.05, the discharge capacity is reduced; and when the molar ratio a exceeds 0.35, the thermal stability is reduced. When the molar ratio b of aluminum is less than 0.005, the thermal stability is reduced; and when the molar ratio b exceeds 0.1, the discharge capacity is reduced. When the molar ratio c of the element M¹ is less than 0.0001, the thermal stability is reduced; and when the molar ratio c exceeds 0.05, the discharge capacity is reduced. When the molar ratio d of the element M² is less than 0.0001, the stability in crystal structure during charge is reduced; and when the molar ratio d exceeds 0.05, the discharge capacity is reduced.

The lithium-containing metal oxide containing nickel may be a compound represented by the following formula (2):

LiNiₐCo_{b}Mn_{c}M³_{d}O₂ (2)

where M³ is at least one selected from the group consisting of Mg, Ti, Ca, Sr and Zr; 0.25≦a≦0.5; 0≦b≦0.5; 0.25≦c≦0.5; and 0≦d≦0.1. The oxide represented by the above formula (2) has a high bonding strength between oxygen ions and metallic ions, and thus is more excellent in thermal stability than the conventional cobalt-based positive electrode active material. Moreover, the oxide represented by the above formula (2) has a larger discharge capacity than the conventional cobalt-based positive electrode active material. However, when the molar ratio a of nickel is less than 0.25, the discharge capacity is reduced; and when the molar ratio a exceeds 0.5, the operating voltage is reduced.

When the molar ratio b of cobalt exceeds 0.5, the discharge capacity is reduced. It is more preferable that the molar ratio b of cobalt is in the range of 0≦b≦0.2.

When the molar ratio c of manganese is less than 0.25, the bonding between manganese and oxide ions is weakened, and thus the thermal stability is reduced; and when the molar ratio c exceeds 0.5, the discharge capacity is reduced.

Moreover, the inclusion of the element M³ in the oxide represented by the formula (2) produces an advantage of an improved charge and discharge life. However, when the molar ratio d of the element M³ exceeds 0.1, the discharge capacity is reduced. It is more preferable that the molar ratio d of the element M³ is in the range of 0.01≦d≦0.1.

The lithium-containing metal oxide containing nickel may be a spinel-type oxide represented by the following formula (3):

LiNiₐMn_{b}M⁴_{c}O₄ (3)

where M⁴ is at least one selected from the group consisting of Co, Mg, Ti, Ca, Sr and Zr; 0.4≦a≦0.6; 1.4≦b≦1.6; and 0≦c≦0.2. The oxide represented by the formula (3) has an operating voltage of not less than 4.5 V. However, in the both cases where the molar ratio a of nickel is less than 0.4 and exceeds 0.6, the operating voltage is reduced. Similarly, in the both cases where the molar ratio b of manganese is less than 1.4 and exceeds 1.6, the operating voltage is reduced. Moreover, the inclusion of the element M⁴ in the oxide represented by the formula (3) improves the charge and discharge life. However, when the molar ratio c of the element M⁴ exceeds 0.2, the discharge capacity is reduced.

Examples of the binder which can be used in the positive electrode active material layer include, for example, polyvinylidene fluoride, polytetrafluoroethylene and modified acrylic rubber (BM-500B), although not limited to these. When the positive electrode is fabricated using a positive electrode material mixture paste, in the case where polytetrafluoroethylene or modified acrylic rubber (BM-500B) is used as the binder, the binder is preferably used in combination with a thickener. Examples of the thickener include carboxymethyl cellulose, polyethylene oxide and modified acrylic rubber (BM-720H).

The adding amount of the binder is preferably 0.6 to 4 parts by weight per 100 parts by weight of the positive electrode active material; and the adding amount of the thickener is preferably 0.3 to 2 parts by weight per 100 parts by weight of the positive electrode active material.

Examples of the conductive agent to be added into the positive electrode active material layer include, for example, acetylene black, Ketjen Black and various types of graphite. These may be used singly or in combination of two or more. The adding amount of the conductive agent is preferably 1 to 4 parts by weight per 100 parts by weight of the positive electrode active material.

Examples of the negative electrode active material include, for example, various types of natural graphite, various types of artificial graphite, silicon containing composite material, and various alloy materials.

Examples of the binder to be added into the negative electrode active material layer include, for example, a rubber polymer containing styrene units and butadiene units. Such a rubber polymer is exemplified by a styrene-butadiene copolymer (SBR) and an acrylic acid modified SBR, although not limited to these. When the negative electrode is fabricated using a negative electrode material mixture paste, in the case where the binder as described above is used, the binder is preferably used in combination with a thickener including a water-soluble polymer. Preferable as the water-soluble polymer is a cellulose based resin, and particularly preferable is carboxymethyl cellulose. The adding amount of the binder is preferably 0.1 to 5 parts by weight per 100 parts by weight of the negative electrode active material; and the adding amount of the thickener is preferably 0.1 to 5 parts by weight per 100 parts by weight of the negative electrode active material.

Examples of the conductive agent to be added into the negative electrode active material layer include the conductive agent to be added into the positive electrode active material layer.

The non-aqueous electrolyte includes a non-aqueous solvent and a solute dissolved therein. Examples of the non-aqueous solvent include, for example, ethylene carbonate, propylene carbonate, dimethyl carbonate, diethyl carbonate and methyl ethyl carbonate. These may be used singly or in combination of two or more. The non-aqueous solvent is not limited to the solvent above.

Examples of the solute include, for example, a lithium salt such as lithium hexafluorophosphate (LiPF₆) and lithium tetrafluoroborate (LiBF₄). These may be used singly or in combination of two or more.

The non-aqueous electrolyte may include vinylene carbonate, cyclohexylbenzene or a derivative of these as an additive. The inclusion of such an additive into the non-aqueous electrolyte allows to form a coating film derived from the additive on the surface of the active material of the positive electrode and/or the negative electrode. This, for example, ensures the stability during overcharge.

The non-aqueous electrolyte secondary battery having a wound type electrode assembly may be fabricated, for example, in the following manner. The positive electrode, the negative electrode and the porous heat resistant layer interposed between the positive electrode and the negative electrode are wound to form an electrode assembly. Herein, the positive electrode, the negative electrode and the porous heat resistant layer are wound so that a substantially circular cross section or a substantially rectangular cross section of the electrode assembly can be obtained. Thereafter, the electrode assembly thus obtained is inserted into a circular or rectangular battery case, into which a non-aqueous electrolyte is injected. The opening of the battery case is then sealed with a lid, thereby to yield a non-aqueous electrolyte secondary battery.

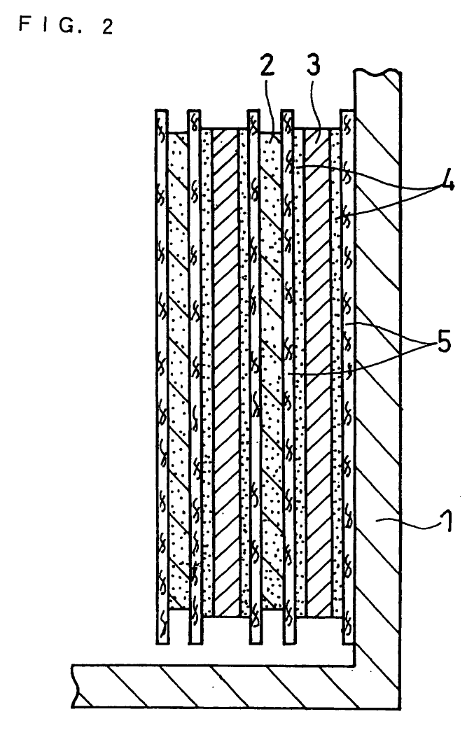

It is preferable that a separator made of resin is disposed between the positive electrode and the porous heat resistant layer or between the negative electrode and the porous heat resistant layer. FIG. 2 shows a part of the electrode assembly in which the separator 5 is disposed between the positive electrode 2 and the porous heat resistant layer 4. In FIG. 2, the same components as in FIG. 1 are denoted by the same reference numerals.

As such, by additionally disposing the separator made of resin between the positive electrode and the porous heat resistant layer or the negative electrode and the porous heat resistant layer, the positive electrode and the negative electrode can be electrically insulated sufficiently via the porous heat resistant layer and the separator made of resin.

It is to be noted that even in the case where the electrode assembly includes the separator made of resin, the value of the above ratio B/A is preferably 70 to 150 ml/m², and more preferably 100 to 110 ml/m². When the above ratio B/A falls within the range as described above, even in the case where the electrode assembly includes the separator, a sufficient amount of non-aqueous electrolyte is presumably absorbed into the porous heat resistant layer, that is, the components capable of swelling included in the porous heat resistant layer (the binder, the heat resistant resin, etc).

Preferable as the separator is a microporous film made of resin and having a melting point of less than 200° C. When the battery causes an external short circuit, the separator melts and the resistance of the battery is increased, thereby to reduce the short circuit current. This makes it possible to prevent an increase in temperature due to heat generation in the battery.

Preferable as the resin as described above forming the separator is polyethylene, polypropylene, a mixture of polyethylene and polypropylene, or a copolymer of ethylene and propylene.

The thickness of the separator is preferably in the range of 10 to 40 μm in view of maintaining the high energy density while securing the ion conductivity. The thickness of the separator made of resin is more preferably in the range of 12 to 23 μm. This is preferable because even when the thickness of the separator made of resin is 3 to 7 μm, it is considered that a sufficient amount of non-aqueous electrolyte is absorbed into the porous heat resistant layer as long as the thickness of the separator made resin is 12 to 23 μm.

The porosity of the separator is preferably 20 to 70%, and more preferably 30 to 60%.

The porous heat resistant layer 4 may be disposed on the separator 5.

The present invention will be hereinafter described in detail with reference to specific Examples. It is to be noted that in the present Examples, wound type cylindrical batteries were fabricated.

### Example 1

### Battery 1

### (Fabrication of a Positive Electrode)

A positive electrode active material mixture paste was prepared by stirring with a double arm kneader 30 kg of LiNi_{0.71}Co_{0.2}Al_{0.05}Mn_{0.02}Mg_{0.02}O₂ as a positive electrode active material, 10 kg of N-methyl-2-pyrrolidone (NMP) solution available from Kureha Chemical Industry Co., Ltd. (solid content: 12% by weight)) of polyvinylidene fluoride (PVDF), 900 g of acetylene black as a conductive agent and an appropriate amount of NMP. The paste was applied onto both faces of an aluminum foil (thickness: 15 μm) as a current collector, then dried and rolled until the total thickness reached 108 μm, whereby a positive electrode plate was obtained. Subsequently, the positive electrode plate was cut so that the dimensions of the positive electrode active material layer per one face of the current collector were a width of 56 mm and a length of 600 mm to yield a positive electrode. The area of the active material layer per one face of the positive electrode current collector was 336 cm².

### (Fabrication of a Negative Electrode and a Porous Heat Resistant Layer)

A negative electrode material mixture paste was prepared by stirring with a double arm kneader 20 kg of artificial graphite, 750 g of an acrylic acid modified product of styrene-butadiene copolymer rubber (BM-400B (trade name) available from Zeon Corporation, Japan; solid content: 40% by weight), 300 g of carboxymethyl cellulose and an appropriate amount of water. The paste thus obtained was applied onto both faces of a cupper foil (thickness: 10 μm) serving as a negative electrode current collector, then dried and rolled until the total thickness reached 119 μm, whereby a negative electrode plate was obtained.

Thereafter, a paste for forming a porous heat resistant layer was prepared by stirring with a double arm kneader 950 g of alumina powder (tap density: 1.2 g/ml) serving as an insulating filler, 625 g of an NMP solution of a modified acrylic rubber (BM-720H available from Zeon Corporation, Japan; solid content: 8% by weight) as a binder and an appropriate amount of NMP. The paste thus obtained was applied onto each of the active material layers carried on both faces of the negative electrode plate with a die coater until the thickness reached 5 μm, and then dried.

Subsequently, the negative electrode plate was cut so that the dimensions of the negative electrode active material layer (i.e., the porous heat resistant layer) per one face of the current collector were a width of 58 mm and a length of 640 mm to yield a negative electrode. The area of the active material layer (the porous heat resistant layer) per one face of the negative electrode current collector was 371 cm².

The porosity of the porous heat resistant layer was 47%. It is to be noted that the porosity of the porous heat resistant layer was 47% in the following batteries and Examples.

The positive electrode and the negate electrode obtained as described above and a microporous separator made of polyethylene (9420G (trade name) available from Asahi Kasei Corporation) disposed between the positive electrode and the negative electrode were wound to fabricate a cylindrical electrode assembly. The thickness of the separator was 20 μm, and the porosity thereof was 42%.

An exposed portion of the positive electrode current collector which is left uncoated with the positive electrode material mixture paste was provided along one side of the positive electrode current collector running in parallel in a longitudinal direction thereof. The exposed portion of the positive electrode current collector was positioned in the upper part of the formed electrode assembly. Similarly, an exposed portion of the negative electrode current collector which is left uncoated with the negative electrode material mixture paste was provided along one side of the negative electrode current collector running in parallel in a longitudinal direction thereof. The exposed portion of the negative electrode current collector was positioned in the lower part of the formed electrode assembly.

To the exposed portion of the positive electrode current collector, a current collector plate (thickness: 0.3 mm) made of aluminum was welded; and to the exposed portion of the negative electrode current collector, a current collector plate (thickness: 0.3 mm) made of iron was welded. Thereafter, the electrode assembly was inserted into a cylindrical battery case having a diameter of 18 mm and a height of 68 mm. Subsequently, a non-aqueous electrolyte was injected in the battery case in an amount of 5.2 ml. As the non-aqueous electrolyte, a solution obtained by dissolving LiPF₆ at a concentration of 1.0 mol/L in a mixture solvent of ethylene carbonate and an ethyl methyl carbonate (volume ratio 1:3) was used.

The opening of the battery case was then sealed to fabricate a cylindrical non-aqueous electrolyte secondary battery 1. The battery capacity (theoretical value) was 850 mAh. Herein, the battery capacity refers to a capacity of the positive electrode, and is determined by multiplying a capacity (145 mAh/g) per unit weight of the positive electrode active material by an amount of the positive electrode active material included in the positive electrode active material layer.

### Batteries 2 to 4

Batteries 2 to 4 were fabricated in the same manner as Battery 1 except that the amount of non-aqueous electrolyte injected was changed to 7.4 ml, 8.2 ml and 11.1 ml.

### Battery 5

The total thickness of the positive electrode was changed to 200 μm, and the length of the positive electrode active material layer per one face of the positive electrode current collector was changed to 300 mm (area of the active material layer per one face of the current collector: 168 cm²). The total thickness of the negative electrode was changed to 227 μm, and the length of the negative electrode active material layer per one face of the negative electrode current collector was changed to 387 mm (area of the active material layer per one face of the current collector: 225 cm²). The diameter of the battery case was changed to 17.5 mm. Battery 5 was fabricated in the same manner as Battery 1 except these.

### Battery 6

The total thickness of the positive electrode was changed to 61 μm, and the length of the positive electrode active material layer per one face of the positive electrode current collector was changed to 1200 mm (area of the active material layer per one face of the current collector: 672 cm²). The total thickness of the negative electrode was changed to 64 μm, and the length of the negative electrode active material layer per one face of the negative electrode current collector was changed to 1240 mm (area of the active material layer per one face of the current collector: 719 cm²). The diameter of the battery case was changed to 20 mm. Battery 6 was fabricated in the same manner as Battery 3 except these.

### Comparative Battery 7

Comparative Battery 7 was fabricated in the same manner as Battery 1 except that the porous heat resistant layer was not provided.

### Comparative Batteries 8 to 9

Comparative Batteries 8 and 9 were fabricated in the same manner as Battery 1 except that the amount of non-aqueous electrolyte injected was changed to 4.8 ml and 11.5 ml.

### Comparative Battery 10

The total thickness of the positive electrode was changed to 370 μm, and the length of the positive electrode active material layer per one face of the positive electrode current collector was changed to 160 mm (area of the active material layer per one face of the current collector: 90 cm²). The total thickness of the negative electrode was changed to 64 μm, and the length of the negative electrode active material layer per one face of the negative electrode current collector was changed to 1240 mm (area of the active material layer per one face of the current collector: 116 cm²). The diameter of the battery case was changed to 17 mm.

Comparative Battery 10 was fabricated in the same manner as Battery 1 except these.

### Comparative Battery 11

Comparative Battery 11 was fabricated in the same manner as Comparative Battery 7 except that the same weight (=4.7 g) of a cobalt-based positive electrode active material (lithium cobalt oxide (LiCoO₂)) was used in place of the lithium-containing metal oxide containing nickel. The theoretical battery capacity of Comparative Battery 11 was 710 mAh.

Table 1 shows an area of the positive electrode active material layer per unit battery capacity, and an area of the negative electrode active material layer, an area A of the porous heat resistance layer, an amount B of the non-aqueous electrolyte, and a ratio B/A of the amount B of the non-aqueous electrolyte relative to the area A of the porous heat resistance layer. These are the same in Tables 3, 5, 7 and 9.

TABLE 1

| | Area of positive | | | | |
|---|---|---|---|---|---|
| | electrode active | Area of negative | Area of | | |
| | material layer | electrode active | porous heat | Amount of | |
| | per unit battery | material layer | resistant | non-aqueous | Ratio |
| | capacity (cm²/Ah) | (cm²) | layer (cm²) | electrolyte (ml) | B/A (ml/m²) |
| Battery 1 | 395 | 371 | 742 | 5.2 | 70 |
| Battery 2 | 395 | 371 | 742 | 7.4 | 100 |
| Battery 3 | 395 | 371 | 742 | 8.2 | 110 |
| Battery 4 | 395 | 371 | 742 | 11.1 | 150 |
| Battery 5 | 198 | 225 | 449 | 5.2 | 116 |
| Battery 6 | 791 | 719 | 1438 | 11.1 | 77 |
| Com. Battery 7 | 395 | 371 | — | 5.2 | — |
| Com. Battery 8 | 395 | 371 | 742 | 4.8 | 65 |
| Com. Battery 9 | 395 | 371 | 742 | 11.5 | 155 |
| Com. Battery 10 | 106 | 116 | 232 | 5.2 | 224 |
| Com. Battery 11 | 395 | 371 | — | 5.2 | — |

With respect to each of the batteries above, the following evaluations were performed.

### (Nail Penetration Test)

Batteries 1 to 11 were charged at a current of 2000 mA until the battery voltage reached 4.35 V. Thereafter, under the environment of 20° C., a 2.7 mm diameter iron nail was driven into the side face of each battery after charge, at a rate of 5 mm/sec. The temperature of each battery 90 seconds after the completion of penetration was measured with a thermocouple mounted on the side face of the battery. The temperature reached after 90 seconds of each battery is shown in Table 2.

### (Vibration Resistance Evaluation)

First, each battery was charged at a constant current of 1400 mA until the battery voltage reached 4.2 V, and then charged at a constant voltage of 4.2 V until the charge current reached 100 mA. Subsequently, the battery after charge was discharged at a constant current of 2000 mA until the battery voltage was reduced to 3 V, thereby to determine a discharge capacity.

Next, each battery was subjected to a vibration test that applies vibration with a pulse width of 50 Hz at 20 G to the battery for 10 hours.

The batteries after the vibration test was subjected to the same charge and discharge cycle once as that performed prior to the vibration test, thereby to determine a discharge capacity after the vibration test.

The ratio of the discharge capacity after the vibration test relative to the discharge capacity before the vibration test was calculated as a percentage, which was referred to as a discharge capacity ratio. The results are shown in Table 2. The discharge capacity rate can be used as an index of vibration resistance.

### (Output Characteristics Evaluation)

Each battery was charged at a current of 1 A until the battery voltage reached 4.2 V, and then discharged at a current of 0.5 A until the battery voltage reached 2.5 V, thereby to determine a discharge capacity. The discharge capacity thus obtained was referred to as a low rate discharge capacity.

Subsequently, the each battery was charged at a current of 1 A until the battery voltage reached 4.2 V, and then discharged at a current of 10 A until the battery voltage reached 2.5 V, thereby to determine a discharge capacity. The discharge capacity thus obtained was referred to as a high rate discharge capacity. The ratio of the high rate discharge capacity relative to the low rate discharge capacity was calculated as a percentage, which was referred to as a high rate/low rate discharge capacity ratio. The results are shown in Table 2.

### (High Temperature Storage Test)

The constant current charge and the constant voltage discharge as performed in the vibration resistance evaluation were performed. The batteries after charge were allowed to stand for 20 days under an environment of 60° C. After 20 days standing, gas was sampled from the interior of the battery and the amount of gas in the interior of the battery was determined by gas chromatography. From the amount of gas thus measured, the amounts of oxygen, nitrogen and volatile components of the non-aqueous electrolyte (non-aqueous solvent) were subtracted, which was referred to as an amount of gas generated. The results are shown in Table 2.

TABLE 2

| | Battery | Discharge | High rate/ | |
|---|---|---|---|---|
| | temperature | capacity ratio | low rate | Amount |
| | after 90 | before and after | discharge | of gas |
| | seconds | vibration test | capacity | generated |
| | (° C.) | (%) | ratio (%) | (ml) |
| Battery 1 | 78 | 65 | 83 | 9.5 |
| Battery 2 | 75 | 78 | 86 | 9.7 |
| Battery 3 | 73 | 100 | 93 | 10.2 |
| Battery 4 | 70 | 100 | 95 | 12.1 |
| Battery 5 | 78 | 75 | 76 | 8 |
| Battery 6 | 71 | 78 | 94 | 12.4 |
| Com. Battery 7 | 134 | 35 | 83 | 9.7 |
| Com. Battery 8 | 79 | 48 | 75 | 9.5 |
| Com. Battery 9 | 72 | 100 | 94 | 14.1 |
| Com. Battery 10 | 77 | 50 | 43 | 7.8 |
| Com. Battery 11 | 137 | 73 | 84 | 9.6 |

In Batteries 1 to 6 in which the porous heat resistant layer was disposed on the negative electrode, overheating in the nail penetration test was prevented and moreover the capacity retention rate in the vibration test was high.

In contrast, in Comparative Battery 7 in which the porous heat resistant layer was not disposed on the negative electrode, the overheating in the nail penetration test was significant. In addition, the capacity retention rate in the vibration test was significantly reduced. In Comparative Battery 8 in which the amount of non-aqueous electrolyte was insufficient with respect to the area of the porous heat resistant layer, the capacity retention rate was reduced, although not so much as that in Comparative Battery 7. This is presumably because when the amount of non-aqueous electrolyte is insufficient, the degree of swelling of the binder included in the porous heat resistant layer is small, and thus the porous heat resistant layer does not expand in volume. Further, in Comparative Battery 9 in which the amount of non-aqueous electrolyte was excessive with respect to the area of the porous heat resistant layer, the capacity retention rate was favorable, but the amount of gas generated during the high temperature storage was significantly great.

The effect achieved by the expanded porous heat resistant layer is significant in a high power output non-aqueous electrolyte secondary battery having a large area of the positive electrode per unit battery capacity of 190 to 800 cm²/Ah. However, as in the case of Comparative Battery 10, when the areas of the active material layers of the positive electrode and the negative electrode are small, the output characteristics are degraded and the area of the porous heat resistant layer is also reduced, resulting in an insufficient volume expansion of the electrode assembly. For this reason, it is considered that the problem of the reduction in capacity due to the winding displacement of the electrode assembly cannot be eliminated.

In Comparative Battery 11 in which lithium cobalt oxide was used as the positive electrode active material, the battery temperature in the nail penetration test was substantially same as that in Comparative Battery 7. However, although not having a porous heat resistant layer, Comparative Battery 11 demonstrated a favorable capacity retention rate (vibration resistance). Since the volume of lithium cobalt oxide varies greatly during charge and discharge, an electrode assembly fabricated using a positive electrode including lithium cobalt oxide also causes a moderate volume expansion. It is considered that the electrode assembly was therefore pressed to the battery case. It should be noted, however, that since the theoretical capacity of lithium cobalt oxide is smaller than that of lithium-containing metal oxide containing nickel, improvement in battery capacity using lithium cobalt oxide is difficult to achieve.

### Example 2

### Batteries 12 to 35

Batteries 12 to 35 were fabricated in the same manner as Battery 2 except that a positive electrode active material represented by the formula (1): LiNi_{1-a-b-c-d}CoₐAl_{b}M¹_{c}M²_{d}O₂ was used and the elements as shown in Table 3 were used as M¹ and M², and the molar ratios of Ni, Co, Al, M¹ and M² were changed as shown in Table 3. Herein, M² contains two to four types of elements. The molar ratio of each elements contained in M² was the same. The molar ratio d is a total molar ratio of the elements of M² in the oxide represented by the formula (1).

TABLE 3

| | LiNi_{1-a-b-c-d}COₐAl_{b}M¹_{c}M²_{d}O₂ | | | | | | |
|---|---|---|---|---|---|---|---|
| | Molar | Molar | Molar | | Molar | | Molar |
| | ratio a | ratio b | ratio c | | ratio d | | ratio |
| | of Co | of Al | of M¹ | Type of M¹ | of M² | Type of M² | of Ni |
| Battery 2 | 0.2 | 0.05 | 0.025 | Mn | 0.025 | Mg + Ca | 0.70 |
| Battery 12 | 0.045 | 0.05 | 0.025 | Mn | 0.025 | Mg + Ca | 0.86 |
| Battery 13 | 0.05 | 0.05 | 0.025 | Mn | 0.025 | Mg + Ca | 0.85 |
| Battery 14 | 0.35 | 0.05 | 0.025 | Mn | 0.025 | Mg + Ca | 0.55 |
| Battery 15 | 0.4 | 0.05 | 0.025 | Mn | 0.025 | Mg + Ca | 0.50 |
| Battery 16 | 0.2 | 0.004 | 0.025 | Mn | 0.025 | Mg + Ca | 0.75 |
| Battery 17 | 0.2 | 0.005 | 0.025 | Mn | 0.025 | Mg + Ca | 0.75 |
| Battery 18 | 0.2 | 0.1 | 0.025 | Mn | 0.025 | Mg + Ca | 0.65 |
| Battery 19 | 0.2 | 0.15 | 0.025 | Mn | 0.025 | Mg + Ca | 0.60 |
| Battery 20 | 0.2 | 0.05 | 0.00005 | Mn | 0.025 | Mg + Ca | 0.72 |
| Battery 21 | 0.2 | 0.05 | 0.0001 | Mn | 0.025 | Mg + Ca | 0.72 |
| Battery 22 | 0.2 | 0.05 | 0.05 | Mn | 0.025 | Mg + Ca | 0.68 |
| Battery 23 | 0.2 | 0.05 | 0.06 | Mn | 0.025 | Mg + Ca | 0.67 |
| Battery 24 | 0.2 | 0.05 | 0.025 | Ti | 0.025 | Mg + Ca | 0.70 |
| Battery 25 | 0.2 | 0.05 | 0.025 | Y | 0.025 | Mg + Ca | 0.70 |
| Battery 26 | 0.2 | 0.05 | 0.025 | Nb | 0.025 | Mg + Ca | 0.70 |
| Battery 27 | 0.2 | 0.05 | 0.025 | Mo | 0.025 | Mg + Ca | 0.70 |
| Battery 28 | 0.2 | 0.05 | 0.025 | W | 0.025 | Mg + Ca | 0.70 |
| Battery 29 | 0.2 | 0.05 | 0.025 | Mn | 0.00005 | Mg + Ca | 0.72 |
| Battery 30 | 0.2 | 0.05 | 0.025 | Mn | 0.0001 | Mg + Ca | 0.72 |
| Battery 31 | 0.2 | 0.05 | 0.025 | Mn | 0.05 | Mg + Ca | 0.68 |
| Battery 32 | 0.2 | 0.05 | 0.025 | Mn | 0.06 | Mg + Ca | 0.67 |
| Battery 33 | 0.2 | 0.05 | 0.025 | Mn | 0.025 | Mg + Ca + Sr | 0.70 |
| Battery 34 | 0.2 | 0.05 | 0.025 | Mn | 0.025 | Mg + Ca + Ba | 0.70 |
| Battery 35 | 0.2 | 0.05 | 0.025 | Mn | 0.025 | Mg + Ca + Sr + Ba | 0.70 |

| | Area of positive | | | | |
|---|---|---|---|---|---|
| | electrode active | Area of negative | | | |
| | material layer | electrode active | Area of porous | Amount of | |
| | per unit battery | material layer | heat resistant | non-aqueous | Ratio |
| | capacity (cm²/Ah) | (cm²) | layer (cm²) | electrolyte (ml) | B/A (ml/m²) |
| Battery 2 | 395 | 371 | 742 | 7.4 | 100 |
| Battery 12 | 395 | 371 | 742 | 7.4 | 100 |
| Battery 13 | 395 | 371 | 742 | 7.4 | 100 |
| Battery 14 | 395 | 371 | 742 | 7.4 | 100 |
| Battery 15 | 395 | 371 | 742 | 7.4 | 100 |
| Battery 16 | 395 | 371 | 742 | 7.4 | 100 |
| Battery 17 | 395 | 371 | 742 | 7.4 | 100 |
| Battery 18 | 395 | 371 | 742 | 7.4 | 100 |
| Battery 19 | 395 | 371 | 742 | 7.4 | 100 |
| Battery 20 | 395 | 371 | 742 | 7.4 | 100 |
| Battery 21 | 395 | 371 | 742 | 7.4 | 100 |
| Battery 22 | 395 | 371 | 742 | 7.4 | 100 |
| Battery 23 | 395 | 371 | 742 | 7.4 | 100 |
| Battery 24 | 395 | 371 | 742 | 7.4 | 100 |
| Battery 25 | 395 | 371 | 742 | 7.4 | 100 |
| Battery 26 | 395 | 371 | 742 | 7.4 | 100 |
| Battery 27 | 395 | 371 | 742 | 7.4 | 100 |
| Battery 28 | 395 | 371 | 742 | 7.4 | 100 |
| Battery 29 | 395 | 371 | 742 | 7.4 | 100 |
| Battery 30 | 395 | 371 | 742 | 7.4 | 100 |
| Battery 31 | 395 | 371 | 742 | 7.4 | 100 |
| Battery 32 | 395 | 371 | 742 | 7.4 | 100 |
| Battery 33 | 395 | 371 | 742 | 7.4 | 100 |
| Battery 34 | 395 | 371 | 742 | 7.4 | 100 |
| Battery 35 | 395 | 371 | 742 | 7.4 | 100 |

With respect to each of the batteries, the following evaluations were performed.

### (Measurement of Heat Generation Starting Temperature)

Each battery was charged at a constant current of mA until the battery voltage reached 4.4 V. Thereafter, the battery after charge was dismantled to remove the positive electrode. The removed positive electrode was encased and sealed in a metallic case and then heated in a constant temperature bath at a heating rate of 5° C./min. The temperature of the constant temperature bath when the surface temperature of the positive electrode layer was 2° C. higher than that of the temperature of the constant temperature bath was referred to as a “heat generation starting temperature”. This temperature can be used as an index of thermal stability of the positive electrode active material. The results are shown in Table 4.

### (Confirmation of Discharge Capacity)

Each battery was charged at a constant current of 850 mA under an environment of 20° C. until the battery voltage reached 4.2 V, and then charged at a constant voltage of 4.2 V until the charge current reached 85 mA. Subsequently, the battery after charge was discharged at a current of 850 mA until the battery voltage was reduced to 2.5 V. The initial discharge capacity obtained herein is shown in Table 4.

### (High Temperature Storage Characteristics Evaluation)

Each battery was charged at a constant current of 850 mA until the battery voltage reached 4.2 V, and then charged at a constant voltage of 4.2 V until the charge current reached 85 mA. The battery after charge was stored under an environment of 60° C. for 20 days. The battery after storage was discharged at a current of 850 mA until the battery voltage was reduced to 2.5 V, thereby to determine a discharge capacity after storage. The ratio of the discharge capacity after storage relative to the initial discharge capacity determined as described above was calculated as a percentage, which was referred to a discharge capacity ratio. The results are shown in Table 4. The discharge capacity ratio can be used as an index of stability in crystal structure of the positive electrode active material after high temperature storage in a charged state. The results of Battery 2 are also shown in Table 4.

TABLE 4

| | Heat generation | Initial discharge | |
|---|---|---|---|
| | starting temperature | capacity | Discharge |
| | (° C.) | (mAh) | capacity ratio (%) |
| Battery 2 | 165 | 847 | 92 |
| Battery 12 | 170 | 831 | 92 |
| Battery 13 | 168 | 847 | 93 |
| Battery 14 | 160 | 855 | 94 |
| Battery 15 | 121 | 859 | 94 |
| Battery 16 | 123 | 857 | 92 |
| Battery 17 | 161 | 855 | 94 |
| Battery 18 | 168 | 843 | 93 |
| Battery 19 | 160 | 819 | 91 |
| Battery 20 | 124 | 845 | 93 |
| Battery 21 | 155 | 845 | 93 |
| Battery 22 | 173 | 843 | 92 |
| Battery 23 | 179 | 802 | 92 |
| Battery 24 | 165 | 845 | 92 |
| Battery 25 | 167 | 842 | 93 |
| Battery 26 | 167 | 842 | 92 |
| Battery 27 | 168 | 843 | 93 |
| Battery 28 | 165 | 841 | 93 |
| Battery 29 | 155 | 845 | 67 |
| Battery 30 | 156 | 845 | 85 |
| Battery 31 | 156 | 844 | 87 |
| Battery 32 | 153 | 829 | 90 |
| Battery 33 | 160 | 840 | 92 |
| Battery 34 | 161 | 840 | 92 |
| Battery 35 | 163 | 838 | 93 |

In Battery 12 in which the molar ratio a of cobalt was 0.045, the discharge capacity was slightly low. In Battery 15 in which the molar ratio a was 0.4, the thermal stability was slightly low.

In Battery 16 in which the molar ratio b of aluminum was 0.004, the thermal stability was slightly low. In Battery 19 in which the molar ratio b was 0.15, the discharge capacity was slightly low.

In Battery 20 in which the molar ratio c of element M¹ was 0.00005, the thermal stability was slightly low. In Battery 23 in which the molar ratio c was 0.06, the discharge capacity was slightly low.

In Battery 29 in which the molar ratio d of element M² was 0.00005, the high temperature storage characteristics were slightly low. In Battery 32 in which the molar ratio d was 0.06, the discharge capacity was slightly low.

From the results above, it is found that when the positive electrode active material is represented by the formula: LiNi_{1-a-b-c-d}CoₐAl_{b}M¹_{c}M²_{d}O₂, it is preferable that M¹ is at least one selected from the group consisting of Mn, Ti, Y, Nb, Mo and W; M² is at least two selected from the group consisting of Mg, Ca, Sr and Ba; Mg and Ca are essential; 0.05≦a≦0.35; 0.005≦b≦0.1; 0.0001≦c≦0.05; and 0.0001≦d≦0.05.

### Example 3

### Batteries 36 to 64

Batteries 36 to 64 were fabricated in the same manner as Battery 2 except that a positive electrode active material represented by the formula (2): LiNiₐCo_{b}Mn_{c}M³_{d}O₂ was used and the molar ratio a of nickel, the molar ratio b of cobalt, the molar ratio c of manganese and the type and the molar ratio d of element M³ were changed as shown in Table 5.

TABLE 5

| | LiNiₐCO_{b}Mn_{c}M³_{d}O₂ | | | | |
|---|---|---|---|---|---|
| | Molar | Molar | Molar | | Molar |
| | ratio a of Ni | ratio b of Co | ratio c of Mn | Type of M³ | ratio d of M³ |
| Battery 36 | 0.2 | 0.4 | 0.4 | — | — |
| Battery 37 | 0.25 | 0.375 | 0.375 | — | — |
| Battery 38 | 0.5 | 0.25 | 0.25 | — | — |
| Battery 39 | 0.55 | 0.225 | 0.225 | — | — |
| Battery 40 | 0.4 | 0.2 | 0.4 | — | — |
| Battery 41 | 0.375 | 0.25 | 0.375 | — | — |
| Battery 42 | 0.25 | 0.5 | 0.25 | — | — |
| Battery 43 | 0.225 | 0.55 | 0.225 | — | — |
| Battery 44 | 0.4 | 0.4 | 0.2 | — | — |
| Battery 45 | 0.375 | 0.375 | 0.25 | — | — |
| Battery 46 | 0.25 | 0.25 | 0.5 | — | — |
| Battery 47 | 0.225 | 0.225 | 0.55 | — | — |
| Battery 48 | 0.317 | 0.317 | 0.317 | Mg | 0.05 |
| Battery 49 | 0.3 | 0.3 | 0.3 | Mg | 0.1 |
| Battery 50 | 0.283 | 0.283 | 0.283 | Mg | 0.15 |
| Battery 51 | 0.317 | 0.317 | 0.317 | Ti | 0.05 |
| Battery 52 | 0.317 | 0.317 | 0.317 | Ca | 0.05 |
| Battery 53 | 0.317 | 0.317 | 0.317 | Sr | 0.05 |
| Battery 54 | 0.317 | 0.317 | 0.317 | Zr | 0.05 |
| Battery 55 | 0.375 | 0.2 | 0.375 | Mg | 0.01 |
| Battery 56 | 0.375 | 0.2 | 0.375 | Ti | 0.01 |
| Battery 57 | 0.375 | 0.2 | 0.375 | Ca | 0.01 |
| Battery 58 | 0.375 | 0.2 | 0.375 | Sr | 0.01 |
| Battery 59 | 0.375 | 0.2 | 0.375 | Zr | 0.01 |
| Battery 60 | 0.475 | 0 | 0.475 | Mg | 0.01 |
| Battery 61 | 0.475 | 0 | 0.475 | Ti | 0.01 |
| Battery 62 | 0.475 | 0 | 0.475 | Ca | 0.01 |
| Battery 63 | 0.475 | 0 | 0.475 | Sr | 0.01 |
| Battery 64 | 0.475 | 0 | 0.475 | Zr | 0.01 |

| | Area of positive | | | | |
|---|---|---|---|---|---|
| | electrode active | Area of negative | | | |
| | material layer | electrode active | Area of porous | Amount of | |
| | per unit battery | material layer | heat resistant | non-aqueous | Ratio B/A |
| | capacity (cm²/Ah) | (cm²) | layer (cm²) | electrolyte (ml) | (ml/m²) |
| Battery 36 | 395 | 371 | 742 | 7.4 | 100 |
| Battery 37 | 395 | 371 | 742 | 7.4 | 100 |
| Battery 38 | 395 | 371 | 742 | 7.4 | 100 |
| Battery 39 | 395 | 371 | 742 | 7.4 | 100 |
| Battery 40 | 395 | 371 | 742 | 7.4 | 100 |
| Battery 41 | 395 | 371 | 742 | 7.4 | 100 |
| Battery 42 | 395 | 371 | 742 | 7.4 | 100 |
| Battery 43 | 395 | 371 | 742 | 7.4 | 100 |
| Battery 44 | 395 | 371 | 742 | 7.4 | 100 |
| Battery 45 | 395 | 371 | 742 | 7.4 | 100 |
| Battery 46 | 395 | 371 | 742 | 7.4 | 100 |
| Battery 47 | 395 | 371 | 742 | 7.4 | 100 |
| Battery 48 | 395 | 371 | 742 | 7.4 | 100 |
| Battery 49 | 395 | 371 | 742 | 7.4 | 100 |
| Battery 50 | 395 | 371 | 742 | 7.4 | 100 |
| Battery 51 | 395 | 371 | 742 | 7.4 | 100 |
| Battery 52 | 395 | 371 | 742 | 7.4 | 100 |
| Battery 53 | 395 | 371 | 742 | 7.4 | 100 |
| Battery 54 | 395 | 371 | 742 | 7.4 | 100 |
| Battery 55 | 395 | 371 | 742 | 7.4 | 100 |
| Battery 56 | 395 | 371 | 742 | 7.4 | 100 |
| Battery 57 | 395 | 371 | 742 | 7.4 | 100 |
| Battery 58 | 395 | 371 | 742 | 7.4 | 100 |
| Battery 59 | 395 | 371 | 742 | 7.4 | 100 |
| Battery 60 | 395 | 371 | 742 | 7.4 | 100 |
| Battery 61 | 395 | 371 | 742 | 7.4 | 100 |
| Battery 62 | 395 | 371 | 742 | 7.4 | 100 |
| Battery 63 | 395 | 371 | 742 | 7.4 | 100 |
| Battery 64 | 395 | 371 | 742 | 7.4 | 100 |

With respect to each of the batteries, the following evaluations were performed.

The heat generation starting temperature of each battery was measured in the same manner as in Example 2. The results are shown in Table 6.

### (Confirmation of Discharge Capacity and Discharge Average Voltage)

Each battery was charged at a constant current of 850 mA under an environment of 20° C. until the battery voltage reached 4.2 V, and then charged at a constant voltage of 4.2 V until the charge current reached 85 mA. Thereafter, the battery after charge was discharged at a current of 850 mA until the battery voltage was reduced to 2.5 V, thereby to determine a discharge capacity. The discharge capacity obtained herein was referred to as an initial discharge capacity. Further, assuming that the initial discharge capacity was L (mAh), the battery voltage obtained when the capacity equivalent to 0.5 L was discharged was referred to as a discharge average voltage. The initial discharge capacity and the discharge average voltage thus determined are shown in Table 6.

### (Life Evaluation)

Each battery was charged at a constant current of 850 mA until the battery voltage reached 4.2 V, and then charged at a constant voltage of 4.2 V until the charge current reached 85 mA. Subsequently, the battery after charge was discharged at a constant current of 850 mA until the battery voltage was reduced to 2.5 V. This charge and discharge cycle was repeated to a total of 500 times. The ratio of the discharge capacity at the 500th cycle relative to the discharge capacity at the first cycle was calculated as a percentage, which was referred to as a capacity retention rate. The capacity retention rate thus determined is shown in Table 6.

The results of Battery 2 are also shown in Table 6.

TABLE 6

| | Heat | | | |
|---|---|---|---|---|
| | generation | | | |
| | starting | Initial discharge | Discharge | Capacity |
| | temperature | capacity | average | retention |
| | (° C.) | (mAh) | voltage (V) | rate (%) |
| Battery 2 | 165 | 847 | 3.43 | 78 |
| Battery 36 | 168 | 795 | 3.67 | 79 |
| Battery 37 | 168 | 847 | 3.64 | 78 |
| Battery 38 | 160 | 860 | 3.56 | 76 |
| Battery 39 | 158 | 862 | 3.41 | 75 |
| Battery 40 | 125 | 851 | 3.61 | 79 |
| Battery 41 | 165 | 849 | 3.6 | 78 |
| Battery 42 | 160 | 845 | 3.63 | 80 |
| Battery 43 | 159 | 798 | 3.64 | 79 |
| Battery 44 | 123 | 850 | 3.61 | 78 |
| Battery 45 | 165 | 846 | 3.6 | 78 |
| Battery 46 | 159 | 841 | 3.65 | 79 |
| Battery 47 | 169 | 790 | 3.65 | 79 |
| Battery 48 | 164 | 846 | 3.64 | 84 |
| Battery 49 | 165 | 845 | 3.61 | 86 |
| Battery 50 | 165 | 801 | 3.62 | 88 |
| Battery 51 | 162 | 846 | 3.63 | 84 |
| Battery 52 | 164 | 846 | 3.61 | 83 |
| Battery 53 | 163 | 845 | 3.61 | 83 |
| Battery 54 | 163 | 844 | 3.62 | 82 |
| Battery 55 | 164 | 850 | 3.61 | 83 |
| Battery 56 | 163 | 850 | 3.61 | 84 |
| Battery 57 | 163 | 850 | 3.62 | 83 |
| Battery 58 | 163 | 848 | 3.61 | 84 |
| Battery 59 | 162 | 849 | 3.61 | 83 |
| Battery 60 | 163 | 843 | 3.61 | 85 |
| Battery 61 | 161 | 844 | 3.62 | 84 |
| Battery 62 | 162 | 844 | 3.61 | 84 |
| Battery 63 | 162 | 843 | 3.62 | 84 |
| Battery 64 | 162 | 843 | 3.61 | 83 |

In Battery 36 in which the molar ratio a of nickel was 0.2, the discharge capacity was slightly low. In Battery in which the molar ratio a was 0.55, the discharge average voltage was slightly low.

In Battery 40 in which the molar ratio b of cobalt was 0.2, the thermal stability was slightly low. In Battery in which the molar ratio b was 0.55, the discharge capacity was slightly low.

In Battery 44 in which the molar ratio c of manganese was 0.2, the thermal stability was slightly low. In Battery 47 in which the molar ratio c was 0.55, the discharge capacity was slightly low, compared with Batteries 44 to 46.

From the results of Batteries 48 to 64, it is found that the addition of the element M³ improves the capacity retention rate. However, in Battery 50 in which the molar ratio d of element M³ was 0.15, the discharge capacity was slightly low.

From the results above, it is found that when the positive electrode active material is represented by the formula: LiNiₐCo_{b}Mn_{c}M³_{d}O₂, it is preferable that M³ is at least one selected from the group consisting of Mg, Ti, Ca, Sr and Zr; 0.25≦a≦0.5; 0≦b≦0.5; 0.25≦c≦0.5; and 0≦d≦0.1.

In addition, from the results of Batteries 55 to 64, it is found that even when the molar ratio a of cobalt is not greater than 0.2, reduction in thermal stability can be more surely suppressed as long as the molar ratio d of M³ is not less than 0.01. Therefore, in the formula: LiNiₐCo_{b}Mn_{c}M³_{d}O₂, it is preferable that M³ is at least one selected from the group consisting of Mg, Ti, Ca, Sr and Zr; 0.25≦a≦0.5; 0≦b≦0.2; and 0.01≦d≦0.1.

### Example 4

### Batteries 65 to 76

Batteries 65 to 76 were fabricated in the same manner as Battery 2 except that a positive electrode active material represented by the formula (3): LiNiₐMn_{b}M⁴_{c}O₄ was used and the molar ratios a to c and the type of M⁴ were changed as shown in Table 7.

TABLE 7

LiNiₐMn_{b}M⁴_{c}O₄

| | Molar | Molar | | Molar |
|---|---|---|---|---|
| | ratio a of Ni | ratio b of Mn | Type of M⁴ | ratio c of M⁴ |
| Battery 65 | 0.3 | 1.7 | — | — |
| Battery 66 | 0.4 | 1.6 | — | — |
| Battery 67 | 0.5 | 1.5 | — | — |
| Battery 68 | 0.6 | 1.4 | — | — |
| Battery 69 | 0.7 | 1.3 | — | — |
| Battery 70 | 0.45 | 1.45 | Mg | 0.1 |
| Battery 71 | 0.4 | 1.4 | Mg | 0.2 |
| Battery 72 | 0.35 | 1.35 | Mg | 0.3 |
| Battery 73 | 0.45 | 1.45 | Ti | 0.1 |
| Battery 74 | 0.45 | 1.45 | Ca | 0.1 |
| Battery 75 | 0.45 | 1.45 | Sr | 0.1 |
| Battery 76 | 0.45 | 1.45 | Zr | 0.1 |

| | Area of positive | | | | |
|---|---|---|---|---|---|
| | electrode active | Area of negative | | | |
| | material layer | electrode active | Area of porous | Amount of | |
| | per unit battery | material layer | heat resistant | non-aqueous | Ratio B/A |
| | capacity (cm²/Ah) | (cm²) | layer (cm²) | electrolyte (ml) | (ml/m²) |
| Battery 65 | 395 | 371 | 742 | 7.4 | 100 |
| Battery 66 | 395 | 371 | 742 | 7.4 | 100 |
| Battery 67 | 395 | 371 | 742 | 7.4 | 100 |
| Battery 68 | 395 | 371 | 742 | 7.4 | 100 |
| Battery 69 | 395 | 371 | 742 | 7.4 | 100 |
| Battery 70 | 395 | 371 | 742 | 7.4 | 100 |
| Battery 71 | 395 | 371 | 742 | 7.4 | 100 |
| Battery 72 | 395 | 371 | 742 | 7.4 | 100 |
| Battery 73 | 395 | 371 | 742 | 7.4 | 100 |
| Battery 74 | 395 | 371 | 742 | 7.4 | 100 |
| Battery 75 | 395 | 371 | 742 | 7.4 | 100 |
| Battery 76 | 395 | 371 | 742 | 7.4 | 100 |

With respect to each of the batteries thus fabricated, the following evaluations were performed.

### (Confirmation of Discharge Average Voltage)

Each battery was charged at a constant current of mA until the battery voltage reached 4.9 V, and then charged at a constant voltage of 4.9 V until the charge current reached 85 mA. Subsequently, the battery after charge was discharged at a constant current of 1700 mA until the battery voltage was reduced to 3.0 V, thereby to determine a discharge capacity. Assuming that the discharge capacity thus determined was L, the battery voltage obtained when the capacity equivalent to 0.5 L was discharged was referred to as a discharge average voltage. The discharge average voltage thus determined is shown in Table 8.

### (Life Evaluation)

Each battery was charged at a constant current of mA until the battery voltage reached 4.9 V, and then charged at a constant voltage of 4.9 V until the charge current reached 85 mA. Subsequently, the battery after charge was discharged at a constant current of 850 mA until the battery voltage was reduced to 3.0 V. This charge and discharge cycle was repeated to a total of 200 times. The ratio of the discharge capacity at the 200th cycle relative to the discharge capacity at the first cycle was calculated as a percentage, which was referred to as a capacity retention rate. The capacity retention rate thus determined is shown in Table 8.

The results of Battery 2 are also shown in Table 8.

TABLE 8

| | Discharge | Capacity |
|---|---|---|
| | average | retention |
| | voltage (V) | rate (%) |
| Battery 2 | 3.43 | 85 |
| Battery 65 | 4.22 | 71 |
| Battery 66 | 4.49 | 74 |
| Battery 67 | 4.55 | 78 |
| Battery 68 | 4.5 | 76 |
| Battery 69 | 4.19 | 70 |
| Battery 70 | 4.53 | 82 |
| Battery 71 | 4.54 | 84 |
| Battery 72 | 4.25 | 84 |
| Battery 73 | 4.53 | 82 |
| Battery 74 | 4.53 | 83 |
| Battery 75 | 4.52 | 83 |
| Battery 76 | 4.54 | 82 |

In Battery 65 in which the molar ratio a of nickel was 0.3 and the molar ratio b of manganese was 1.7, and Battery 69 in which the molar ratio a was 0.7 and the molar ratio b was 1.3, the discharge average voltage was slightly low.

From the results of Batteries 70 to 76, it is found that the addition of the element M⁴ improves the cycle capacity retention rate. However, in Battery 72 in which the molar ratio c of element M⁴ was 0.3, the discharge average voltage was slightly low.

From the results above, it is found that in the positive electrode active material represented by the formula: LiNiₐMn_{b}M⁴_{c}O₄, it is preferable that M⁴ is at least one selected from the group consisting of Co, Mg, Ti, Ca, Sr and Zr, 0.4≦a≦0.6, 1.4≦b≦1.6, and 0≦c≦0.2.

### Example 5

### Batteries 77 to 88

Batteries 77 to 88 were fabricated in the same manner as Battery 1 except that a mixture obtained by mixing lithium-containing metal oxides containing nickel with a typical composition, LiNi_{0.71}Co_{0.2}Al_{0.05}Mn_{0.02}Mg_{0.02}O₂, LiNi_{0.375}Co_{0.375}Mn_{0.25}O₂ and LiNi_{0.5}Mn_{1.5}O₄, at a ratio as shown in Table 9 was used as the positive electrode active material.

TABLE 9

| | Positive electrode active material | | |
|---|---|---|---|
| | LiNi_{0.71}Co_{0.2}Al_{0.05}—Mn_{0.02}Mg_{0.02}O₂ | LiNi_{0.375}Co_{0.375}Mn_{0.25}O₂ | LiNi_{0.5}Mn_{1.5}O₄ |
| Battery 77 | 5 | 95 | 0 |
| Battery 78 | 50 | 50 | 0 |
| Battery 79 | 95 | 5 | 0 |
| Battery 80 | 5 | 0 | 95 |
| Battery 81 | 50 | 0 | 50 |
| Battery 82 | 95 | 0 | 5 |
| Battery 83 | 0 | 5 | 95 |
| Battery 84 | 0 | 50 | 50 |
| Battery 85 | 0 | 95 | 5 |
| Battery 86 | 5 | 5 | 90 |
| Battery 87 | 5 | 90 | 5 |
| Battery 88 | 90 | 5 | 5 |

| | Area of positive | | | | |
|---|---|---|---|---|---|
| | electrode active | Area of negative | | | |
| | material layer | electrode active | Area of porous | Amount of | |
| | per unit battery | material layer | heat resistant | non-aqueous | Ratio |
| | capacity (cm²/Ah) | (cm²) | layer (cm²) | electrolyte (ml) | B/A (ml/m²) |
| Battery 77 | 325.9 | 347 | 693 | 4.9 | 70 |
| Battery 78 | 358.6 | 382 | 763 | 5.3 | 70 |
| Battery 79 | 391.4 | 416 | 833 | 5.8 | 70 |
| Battery 80 | 286.4 | 305 | 609 | 4.3 | 70 |
| Battery 81 | 337.8 | 359 | 719 | 5.0 | 70 |
| Battery 82 | 389.3 | 414 | 828 | 5.8 | 70 |
| Battery 83 | 282.7 | 301 | 602 | 4.2 | 70 |
| Battery 84 | 301.4 | 321 | 641 | 4.5 | 70 |
| Battery 85 | 320.2 | 341 | 681 | 4.8 | 70 |
| Battery 86 | 288.5 | 307 | 614 | 4.3 | 70 |
| Battery 87 | 323.8 | 345 | 689 | 4.8 | 70 |
| Battery 88 | 385.6 | 410 | 821 | 5.7 | 70 |

Each battery thus fabricated was subjected to the nail penetration test and the vibration test in the same manner as in Example 1. The results are shown in Table 10.

TABLE 10

| | | Discharge capacity |
|---|---|---|
| | Battery temperature | ratio before and |
| | after 90 seconds | after vibration test |
| | (° C.) | (%) |
| Battery 77 | 73 | 76 |
| Battery 78 | 75 | 70 |
| Battery 79 | 78 | 66 |
| Battery 80 | 77 | 78 |
| Battery 81 | 77 | 72 |
| Battery 82 | 78 | 67 |
| Battery 83 | 75 | 77 |
| Battery 84 | 75 | 77 |
| Battery 85 | 74 | 77 |
| Battery 86 | 75 | 77 |
| Battery 87 | 76 | 71 |
| Battery 88 | 77 | 68 |

From the results as shown in Table 10, it is found that even in the case where two or more lithium-containing metal oxides containing nickel as described above were mixed, the same level of safety against nail penetration and vibration resistance can be achieved as in the case of using them singly.

### INDUSTRIAL APPLICABILITY

According to the prevent invention, it is possible to provide a high capacity non-aqueous electrolyte secondary battery with excellent output characteristics and favorable vibration resistance. Such a non-aqueous electrolyte secondary battery can be used as a power source for driving equipment requiring high power output, for example, in the use for HEV application or electric power tool application.

1. A non-aqueous electrolyte secondary battery comprising a positive electrode, a negative electrode and a non-aqueous electrolyte, wherein
said positive electrode includes a positive electrode active material layer and said negative electrode includes a negative electrode active material layer,
said positive electrode active material layer includes a lithium-containing metal oxide containing nickel as a positive electrode active material,
an area of said positive electrode active material layer per unit battery capacity is in a range of 190 to 800 cm²/Ah,
a porous heat resistant layer is disposed between said positive electrode and said negative electrode, and
a ratio of an amount of said non-aqueous electrolyte relative to an area of said porous heat resistance layer is 70 to 150 ml/m².

2. The non-aqueous electrolyte secondary battery in accordance with claim 1, wherein a microporous separator made of resin is disposed between said positive electrode and said porous heat resistant layer or between said negative electrode and said porous heat resistant layer.

3. The non-aqueous electrolyte secondary battery in accordance with claim 1, wherein said positive electrode active material is a compound represented by the following formula (1):
LiNi_{1-a-b-c-d}CoₐAl_{b}M¹_{c}M²_{d}O₂ (1)
where M¹ is at least one selected from the group consisting of Mn, Ti, Y, Nb, Mo and W; M² is at least two selected from the group consisting of Mg, Ca, Sr and Ba; Mg and Ca are essential; 0.05≦a≦0.35; 0.005≦b≦0.1; 0.0001≦c≦0.05; and 0.0001≦d≦0.05.

4. The non-aqueous electrolyte secondary battery in accordance with claim 1, wherein said positive electrode active material is a compound represented by the following formula (2):
LiNiₐCo_{b}Mn_{c}M³_{d}O₂ (2)
where M³ is at least one selected from the group consisting of Mg, Ti, Ca, Sr and Zr; 0.25≦a≦0.5; 0≦b≦0.5; 0.25≦c≦0.5; and 0≦d≦0.1.

5. The non-aqueous electrolyte secondary battery in accordance with claim 4, wherein 0≦b≦0.2 and 0.01≦d≦0.1 in said formula (2).

6. The non-aqueous electrolyte secondary battery in accordance with claim 1, wherein said positive electrode active material is a compound represented by the following formula (3):
LiNiₐMn_{b}M⁴_{c}O₄ (3)
where M⁴ is at least one selected from the group consisting of Co, Mg, Ti, Ca, Sr and Zr; 0.4≦a≦0.6; 1.4≦b≦1.6; and 0≦c≦0.2.

7. The non-aqueous electrolyte secondary battery in accordance with claim 1, wherein said positive electrode active material includes at least two selected from the group consisting of the compound represented by the following formula (1):
LiNi_{1-a-b-c-d}CoₐAl_{b}M¹_{c}M²_{d}O₂ (1)
where M¹ is at least one selected from the group consisting of Mn, Ti, Y, Nb, Mo and W; M² is at least two selected from the group consisting of Mg, Ca, Sr and Ba; Mg and Ca are essential; 0.05≦a≦0.35; 0.005≦b≦0.1; 0.0001≦c≦0.05; and 0.0001≦d≦0.05;
the compound represented by the following formula (2):
LiNiₐCo_{b}Mn_{c}M³_{d}O₂ (2)
where M³ is at least one selected from the group consisting of Mg, Ti, Ca, Sr and Zr; 0.25≦a≦0.5; 0≦b≦0.5; 0.25≦c≦0.5; and 0≦d≦0.1; and
the compound represented by the following formula (3):
LiNiₐMn_{b}M⁴_{c}O₄ (3)
where M⁴ is at least one selected from the group consisting of Co, Mg, Ti, Ca, Sr and Zr; 0.4≦a≦0.6; 1.4≦b≦1.6; and 0≦c≦0.2.

8. The non-aqueous electrolyte secondary battery in accordance with claim 1, wherein said porous heat resistant layer is bonded on said positive electrode active martial layer or said negative electrode active material layer.

9. The non-aqueous electrolyte secondary battery in accordance with claim 1, wherein said porous heat resistant layer includes an insulating filler and a binder.

10. The non-aqueous electrolyte secondary battery in accordance with claim 9, wherein said insulating filler is an inorganic oxide.
